(19) United States
(12) Patent Application Publication
(10) Pub. No.: US 2013/0238463 A1
(43) Pub. Date: Sep. 12, 2013

(54) INFORMATION PROCESSOR AND PROGRAM FOR IDENTIFYING ORDER DEADLINE

(71) Applicant: TOSHIBA TEC KABUSHIKI KAISHA, Tokyo (JP)

(72) Inventor: Masatoshi NISHIDA, Tokyo (JP)

(73) Assignee: TOSHIBA TEC KABUSHIKI KAISHA, Tokyo (JP)

(21) Appl. No.: 13/783,170

(22) Filed: Mar. 1, 2013

(30) Foreign Application Priority Data
Mar. 6, 2012 (JP) 2012-049647

(51) Int. Cl. G06Q 30/06

(52) U.S. Cl. CPC G06Q 30/0609
USPC 705/26.35

(57) ABSTRACT

According to an embodiment, an information processor is provided, the information processor comprising an accepting module configured to accept access from a terminal device connected via a network, an image generating module configured to generate a purchase image including an order for purchase of one or more products, and an image sending module configured to send the purchase image to the terminal device. The purchase image includes an order deadline as a measure of safety for the product in accepting the purchase order on the purchase image.

### CROSS-REFERENCE TO RELATED APPLICATION

This application is based upon and claims the benefit of priority from Japanese Patent Application No. 2012-049647, filed Mar. 6, 2012; the entire contents of which are incorporated herein by reference.

### FIELD

Embodiments described herein relate to an information processor and a program. More particularly, the embodiments described herein relate to identifying goods having an expiration date and managing purchases of same.

### BACKGROUND

In recent years, with popularization of networks, the sales system whereby sales of products is carried out via internet(electronic commerce, “EC”) has become popular. In addition, in supermarkets and other shops, products for sale in the shop are also sold via internet in the so-called online grocery store. For the online grocery store, when an order of purchase of a product is received from a customer, the operation for picking and collecting the corresponding product in the shop (“picking”) and the operation of packing of the collected product for the corresponding customer are carried out. The products are then shipped to the appropriate customers.

However, the conventional scheme has the following problem. For the online grocery store on the internet, when an order of purchase of product is received from a customer, there is no deadline as a measure of safety for the product ordered (shelf life, expiration date). Thus, the customer making the order feels uneasy about how and when the product is to be delivered, which is undesirable.

### DESCRIPTION OF THE DRAWINGS

FIG. 1 is a schematic diagram illustrating a sales system according to an embodiment.

FIG. 2 is a block diagram illustrating an online grocery store according to the embodiment.

FIG. 3 is a schematic diagram illustrating an example of an order management file.

FIG. 4 is a schematic diagram illustrating an example of a delivery management file.

FIG. 5 is a schematic diagram illustrating an example of a stock management file.

FIG. 6 is a front view illustrating an example of a delivery date/hour assignment page.

FIG. 7 is a front view illustrating an example of a top page of product sales.

FIG. 8 is a front view illustrating an example of a product purchase page.

FIG. 9 is a flow chart illustrating a flow of a picking slip issuing process.

FIG. 10 is a plane view illustrating an example of the picking slip.

### DETAILED DESCRIPTION

In general, according to one embodiment, the information processor and program according to the embodiments of the present invention will be explained in detail with reference to the attached drawings. However, the present invention is not limited to the embodiments.

According to an embodiment of the present application, an information processor is provided, the information processor comprising an accepting module configured to accept access from a terminal device connected via a network, an image generating module configured to generate a purchase image including an order for purchase of one or more products, and an image sending module configured to send the purchase image to the terminal device. The purchase image includes an order deadline as a measure of safety for the product in accepting the purchase order on the purchase image.

According to another embodiment of the present application, a non-transitory computer-readable storage medium that stores a computer program is provided. The computer program is configured to causes a computer to perform as an accepting module configured to accept access from a terminal device connected via a network, an image generating module configured to generate a purchase image including an order for purchase of one or more products, and an image sending module configured to send the purchase image to the terminal device. The purchase image includes an order deadline for accepting the purchase order as a measure of safety for the product.

According to another embodiment of the present application, an information processor is provided. The information processor includes an access module configured to access a server, an ordering module configured to send an order request for one or more products selected for purchase, and an image receiving module configured to receive a purchase image including order information for the one or more products selected for purchase. The purchase image includes an order deadline for confirming the order as a measure of safety for at least one of the one or more products.

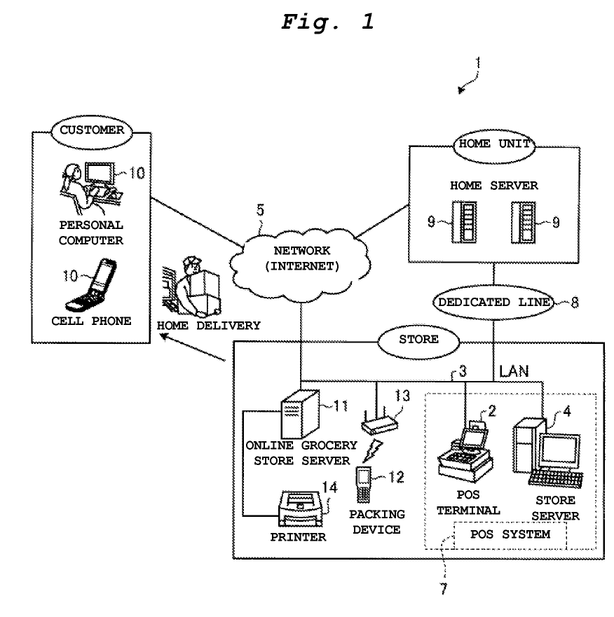

FIG. 1 is a schematic diagram illustrating the overall sales system 1 in the embodiment. As shown in FIG. 1, the sales system 1 includes a POS (Point Of Sale) system 7 that has several POS terminals 2 and a store server 4 that has the various POS terminals 2 connected by LAN 3. The store server 4 provides for centralized management of the POS terminals. The sales system 1 also includes a home server 9 that connects the store server 4 via a dedicated line 8.

In the following, a brief account will be given on the POS system 7 and the home server 9. The store server 4 has a product master file that stores various types of product information for sales in a store, and it receives the overall control of the POS system 7. The store server 4 has a keyboard, a display unit, a printer, and a hard disk drive device, etc. (not shown) connected to it.

The POS terminals 2 are terminals set at settlement locations for a cashier to carry out a sales process. The POS terminal 2 has a keyboard, a drawer, a display unit, a card reader/writer, a code scanner, etc. connected to it. As the POS terminal 2 reads a product code attached to each product (such as a barcode or a two-dimensional code or the like) by a code scanner, the product code is notified to a store server 4 to carry out inquiry on the product. The store server 4 searches the product master file corresponding to the inquiry from the POS terminal 2, reads the product information corresponding to the corresponding product code and sends the product information to the POS terminal 2. The POS terminal 2 acquires the unit price, etc. of the corresponding product from the store server 4. Also, on the basis of the unit price and sales quantity of the product as the purchase object, the POS terminal 2 calculates the total amount of the product, and other processes to generate the sales data. Then, it sends the sales data to the store server 4 at a prescribed timing.

The store server 4 also functions as a stock management device. As products are delivered to the store, the store server 4 manages and stores delivery data (product code, order date, arrival date, quantity for each arrival date, and delivery deadline based on shelf life and/or expiration date, discussed further below) for the delivered products. The store server also adjusts the stock quantity of each product based on the sales data sent from the POS terminals 2.

The home server 9 includes a CPU (central processing unit), a ROM (read-only memory), a RAM (random access memory), etc. The home server 9 manages the sales data sent from the store server 4 in each shop. The home server 9 also it sends the product master file to the store server 4 in each shop.

In addition, as shown in FIG. 1, the sales system 1 has an online grocery store server 11 for providing online grocery store service for the sale of products in the store where the POS system 7 is set via the internet or other network 5. The online grocery store server 11 can be connected to a customer terminal 10 via the network 5.

The customer terminal 10 is a terminal device such as a personal computer (PC), cell phone, etc. manipulated by the customer (user) of the online grocery store. The customer terminal 10 has a control part including a CPU, a ROM, a RAM, etc., an input device of keyboard and various types of buttons, a display unit of CRT, LCD, or the like, a storage device, such as HDD, flash memory, etc., and a communication interface that can be connected to the network 5, etc. (all not shown in the drawing). The customer terminal 10 can realize various types of functions as the control part executes a prescribed program (such as Web browser or the like) stored in the storage device.

In the store, in addition to the online grocery store server 11, there is also a packing device 12 for the packing operation wherein the corresponding products are collected in the store and assigned to various customers according to the ordered product list received by the online grocery store server 11. The packing device 12 may be a portable terminal or the like that can be carried by the operator who carries out the packing operation (hereinafter to be referred to as a packing operator).

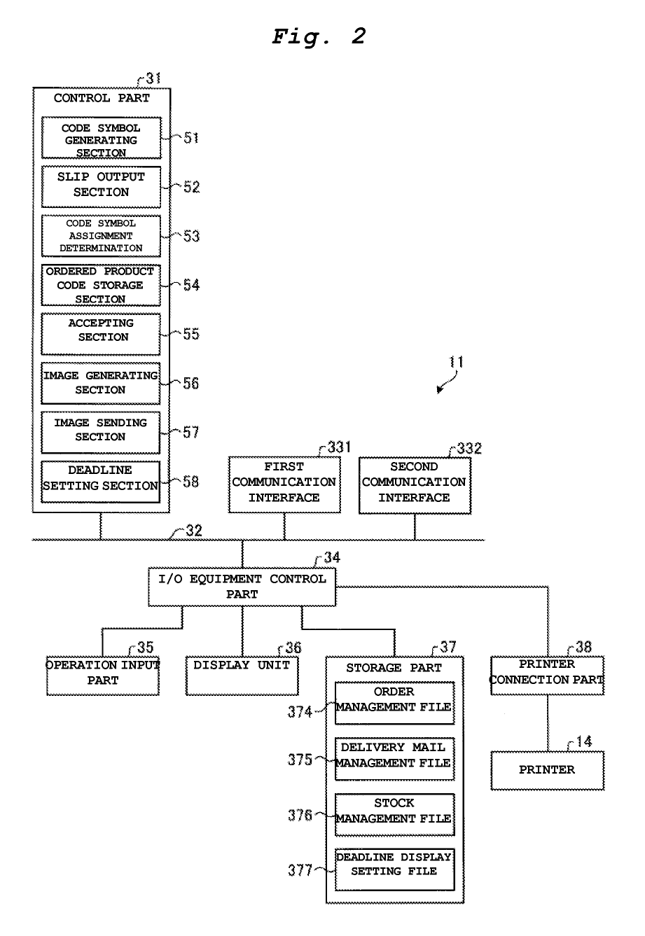

The online grocery store server 11 is a server device that provides the online grocery store service. At the same time, it is an information processor that manages various types of data needed for providing the online grocery store service. Its electronic system has a configuration shown, for example, in FIG. 2.

Here, FIG. 2 is a block diagram illustrating the online grocery store server 11. As shown in FIG. 2, the online grocery store server 11 has the following parts: a control part 31 with a computer constitution including a CPU, a ROM, a RAM, etc., a bus 32, the first communication interface 331 that can be connected to the LAN 3, a second communication interface 332 that can be connected to the network 5, an I/O equipment control part 34, an operation input part 35 including a keyboard, a mouse, etc., a display unit 36 made of CRT, LCD, or other display device, a storage part 37 made of HDD, flash memory, or other storage device, and a printer connecting part 38 connected to a printer 14.

The control part 31 has a configuration that can execute online communication with the packing device 12 via the relay device 13 by the first communication interface 331 connected to the bus 32. The control part 31 also can execute online communication with the online grocery store server 11 via the second communication interface 332 connected to the bus 32. Also, the control part 31 is connected via the bus 32 and the I/O equipment control part 34 to the operation input part 35, the display unit 36, and the storage part 37.

The storage part 37 stores various types of programs (such as Web application, database program, etc.) executed by the control part 31, and the various types of set information related to execution of the programs. The control part 31 realizes operation of the various types of functional parts by working together with the prescribed program stored in the storage part 37. The control part 31 executes the packing treatment and the defective product check treatment, etc. together with the packing device 12.

The storage part 37 stores the following data needed for providing the online grocery store service: order management file 374, delivery mail management file 375, stock management file 376, deadline display setting file 377, etc.

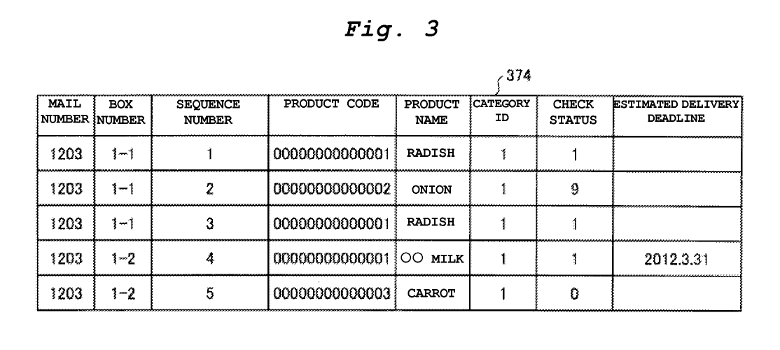

FIG. 3 is a schematic diagram illustrating an example of the order management file 374. The order management file 374 is a data table for management of the order product list by the control part 31, to be explained later, The order product list is stored in ordered product code storage section 54. As shown in FIG. 3, the order management file 374 includes records associated with the mail number, box number, sequence number, product code, product name, category ID, check status, and the estimated delivery deadline based on the shelf life and/or expiration date.

Here, the mail number is an identifier for identifying a specific shipment for delivering the product. The products with the same mail number are delivered with the same shipment. The box number is an identifier for identifying the box for accommodating the products for delivery. The product code and product name are included in the order management file 374 for the product purchased (i.e., ordered) from the online grocery store. The box(es) containing the ordered products for each mail number (shipment) is delivered to the customer who made the order. Each box is designated with the abox number beforehand in the form of a barcode or a 2-dimensional code or other code symbol. The sequence number is a management number that is assigned sequentially to the products with the same mail number.

The check status is information indicating whether the packing treatment has been carried out and whether the product is a defective product. According to the present embodiment, a check status of 0 indicates that the packing treatment has not been carried out, and a check status of 1 indicates that the packing treatment has been carried out. Also, when the check status is 9, it indicates that the product is defective. The initial (default) state of the check status is set at 0.

The estimated delivery deadline (based on shelf life and/or expiration date) will now be explained in detail. Generally speaking, the estimated delivery deadline is the deadline as the measure of safety for the ordered product defined on the basis of the delivery date, the delivery time, etc. set when the order is made. Food expiration date is set by the manufacturer. Usually, it refers to the deadline until which the food that cannot be stored for a long period of time is edible. For example, for some food products, degradation in the food quality takes place after about 5 days with a certain storage method. For food products that can be stored for a long period of time (i.e., over 5 days) the food expiration date can be defined according to applicable government regulations or laws.

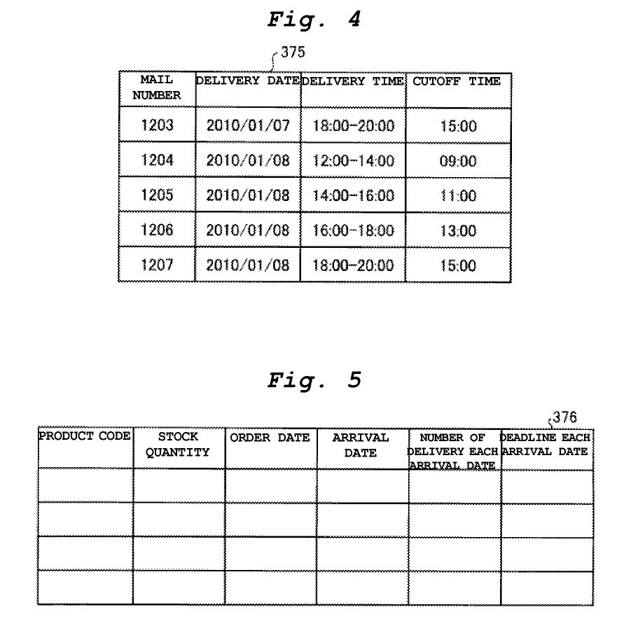

The delivery mail management file 375 is a data table for managing the delivery date/hour corresponding to each mail number. FIG. 4 is a schematic diagram illustrating an example of the delivery mail management file 375. As shown in FIG. 4, the delivery mail management file 375 is correlated to the mail number, and it stores the delivery date, the delivery time, and the cutoff time.

The delivery date and the delivery time indicate the date and the time period for delivery of products. The cutoff time indicates the last time for acceptance of the corresponding mail number. For example, in FIG. 4, the cutoff time is 3 h before the delivery time. On the basis of the current date/hour counted by an RTC (Real Time Clock) or other time counting unit, if the current time is beyond the cutoff time, the record of the delivery mail is deleted from the delivery mail management file 375.

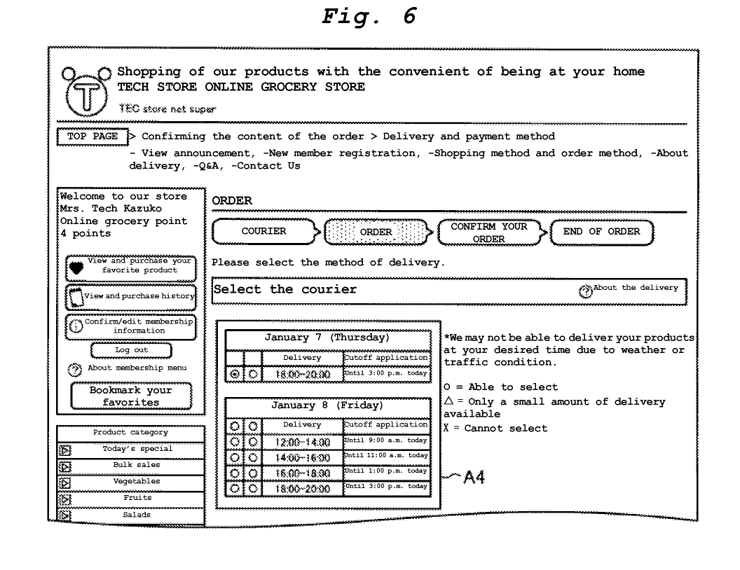

The stock management file 376 is a data table for managing and tracking the stock of products in the store by the control part 31. FIG. 5 is a schematic diagram illustrating an example of the stock management file 376. As shown in FIG. 5, the stock management file 376 includes the product code, the stock quantity, the ordering date, the arrival date, the delivery quantity for each arrival date, and the delivery deadline for each arrival date. Such stock management file 376 receives certain data—such as the stock quantity, the arrival date, the delivery quantity for each arrival date, and the deadline for each arrival date—from the store server 4 that functions as the stock management device.

In the deadline display setting file 377, the lower-limit deadline for the delivery deadline assigned to the effective ordered product is set. For example, for each product code, the lower-limit deadline, such as 3 days after the delivery date and delivery time (such as same-day delivery if order is made in the morning) or the like, is set for each product code.

Together with the image display program stored in the storage part 37, the control part 31 of the online grocery store server 11 realizes the operation of the various types of functional parts (accepting section 55, image generating section 56, image sending section 57, deadline setting section 58, etc.). Likewise, the control part 31 executes the image display treatment.

An example of the operation until purchase (ordering) of the product in the online grocery store will be explained. First, with the control part of the customer terminal 10, corresponding to the operation of the user, access to the address of the EC site is provided by the online grocery store server 11. The control part 31 of the online grocery store server 11 (accepting section 55) carries out acceptance of access from the customer terminal 10. In the basis of the image display program stored in the storage part 37, the initial page of the EC site that carries out sales of product is generated, and it is sent to the customer terminal 10. With the online grocery store server 11, the delivery date/hour assigning page for receiving the assignment of the delivery date/hour is generated as the initial page, and it is sent to the customer terminal 10. The customer terminal 10 has the delivery date/hour assignment page provided by the online grocery server 11 displayed on the display unit (not shown in the drawing). The customer terminal 10 then stands by for the input of operation by the user.

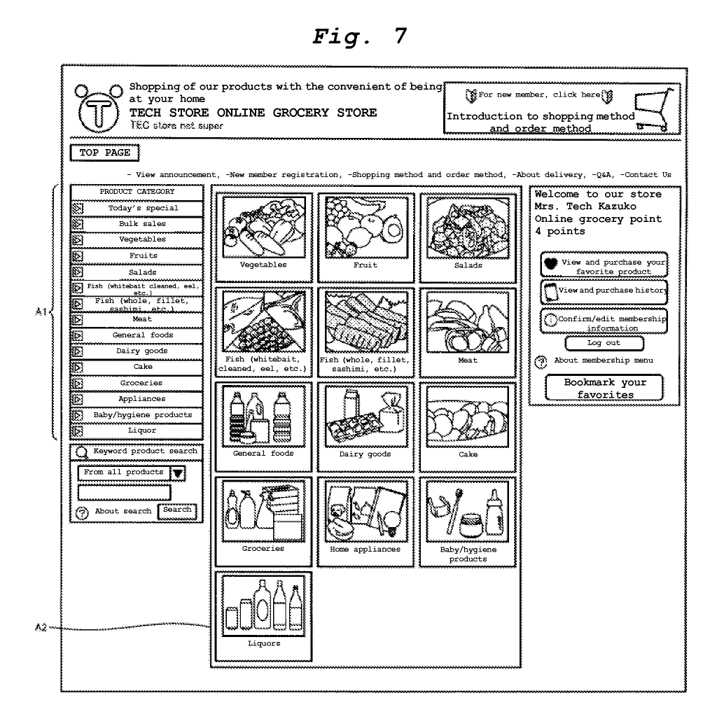

FIG. 6 is a front view illustrating an example of the delivery date/hour assignment page. As shown in FIG. 6, the region A4 on the delivery date/hour assignment page is formed so that it is possible to select the delivery date/hour corresponding to the various mail numbers held in the delivery mail management file 375. As the customer terminal 10 receives of the customer's selection of the specific delivery date/hour (via a keyboard, a mouse or the like not shown in the drawing) the selected delivery date/hour is notified to the online grocery store server 11.

When the online grocery store server 11 receives a notification of the delivery date/hour from the customer terminal 10, it generates the top page of the product sales, and sends it to the customer terminal 10. The customer terminal 10 displays the top page of product sales provided from the online grocery store server 11 on the display unit (not shown in the drawing). The customer terminal 10 then stands by to wait the operation of input by the user.

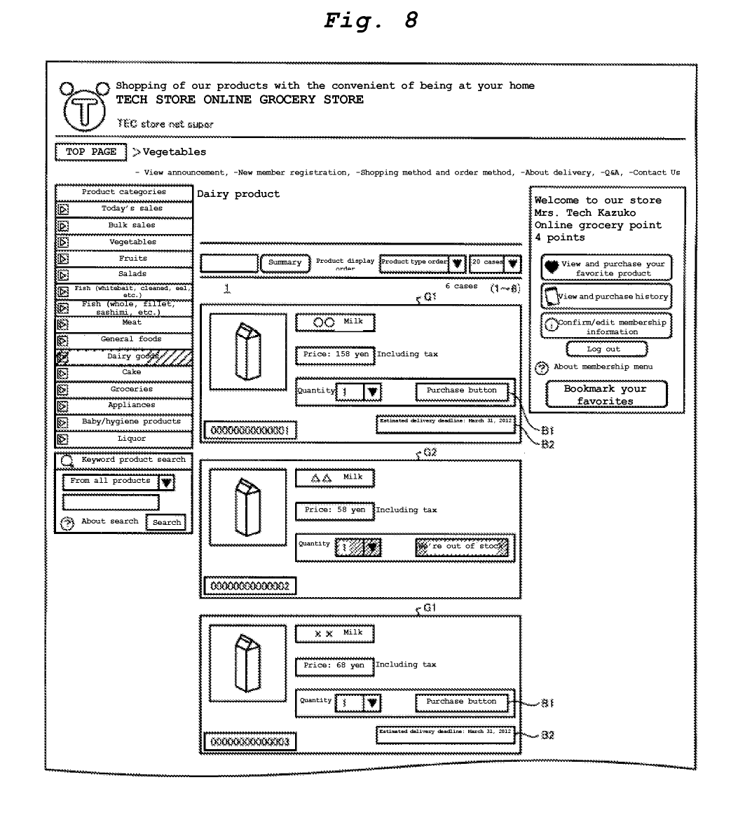

FIG. 7 is a front view illustrating an example of the top page of product sales. FIG. 7 lists in the region A1 the letter sequences of the various product categories (such as vegetables, fruits, etc.). In addition, region A2 lists the icon images corresponding to the various product categories.

The customer terminal 10 works as follows: when it is detected that the prescribed product category (such as the deli product) is selected from the several product categories displayed in region A1 or region A2 of the top page of the product sales, it notifies the online grocery store server 11 that the particular product category has been selected.

Then the selection notification of the product category is received from the customer terminal 10, the online grocery store server 11 refers to the product master file stored in the store server 4, and reads the record corresponding to the product category. In addition, as the selection notification of the product category is received from the customer terminal 10, the online grocery store server 11 refers to the stock management file 376 and the deadline display setting file 377 stored in the online grocery store server 11. For the record corresponding to the product category, the online grocery store server 11 reads the lower-limit deadline (shelf life, expiration date) from the delivery date and the delivery time. Then, the control part 31 (image generating section 56, deadline setting section 58) of the online grocery store server sets the deadline (shelf life, expiration date) corresponding to the read record and the planned delivery date of the record and generates the product purchase page for receiving the purchase order. Further, the control part 31 (image sending section 57) of the online grocery store server 11 sends the product purchase page to the customer terminal 10. The customer terminal 10 displays the product purchase page provided by the online grocery store server 11 on a display unit (not shown in the drawing) The customer terminal 10 then stands by to wait the input operation of the user.

FIG. 8 is a front view illustrating an example of the product purchase page. As shown in FIG. 8, the product purchase page has the purchase image G1 corresponding to the product read from the product master file. As shown in FIG. 8, on the purchase image G1 for each product on the product purchase page, the product image, product name, and product code read from the product master file are displayed.

In addition, as shown in FIG. 8, the estimated delivery deadline B2 is also displayed on the purchase image G1 for each product on the product purchase page. The estimated delivery deadline B2 is defined on the basis of the delivery date and delivery time selected by the delivery date/hour assignment page shown in FIG. 6, the delivery deadline for each product code by the stock management file 376, and the lower-limit deadline of the deadline (shelf life, expiration date) assigned to the ordered product for each product code with the deadline display setting file 377. For example, when the lower-limit deadline of the expiration date for the “OO milk” is set as “within 3 days” by the deadline display setting file 377, if the arrival date is within the 3-day period from the delivery date in the stock management file 376, the date after 3 days from the arrival date is taken as the estimated delivery deadline.

As another example, when the lower-limit deadline of the expiration date for the “OO milk” is set as “within 3 days” by the deadline display setting file 377, if there is no arrival date within the 3-day deadline from the delivery date in the stock management file 376 and there is also no arrival date later than 3 days from the delivery date, the date of 1 to 2 days from the delivery date is taken as the estimated delivery deadline, or as the time of cutoff.

In this way, as the estimated delivery deadline B2 is displayed, the user of the online grocery store can purchase the product with ease of mind. For example, in the prior art, suppose a customer wants to purchase two bottles of milk from an online grocery store, the customer may hesitate on whether to make the purchase due to a concern that the expiration date of the milk may have passed or may pass prior to delivery. Now, as the estimated delivery deadline B2 can be taken as a reference, the customer can purchase the two bottles of milk with ease of mind. That is, when a product with a short expiration date, such as milk, is purchased in bulk in the online grocery store, the user can purchase an appropriate quantity in consideration of the consumption rate just as he/she makes the purchase in a real store.

In addition, there is no need to display the estimated delivery deadline B2 for all of the products. It is all right to display the estimated delivery deadline B2 only for the foods whose quality may degrade significantly within a certain time such as 5 days (for example, lean meat or raw fish meat, and daily delivery foods such as bread, cake, bento, salad, etc.) and other foodstuffs required to have the expiration date notation as well as the category made of such foods.

At the customer terminal 10, each time when the purchase button B1 set on the purchase image G1 is pressed and this action is received via a keyboard or a mouse or the like, the corresponding product code, category and its purchase quantity are sent to the online grocery store server 11 as the purchase object. Then, as the instruction of end of product selection is received, the customer terminal 10 notifies the end of the selection to the online grocery store server 11.

As the notification of end of selection is received from the customer terminal 10, the online grocery store server 11 generates the ordered product list by correlating the product codes and the estimated delivery deadline of the various ordered products to the mail number corresponding to the delivery date/hour notified before.

Each time that an ordered product list is generated, the control part 31 of the online grocery store server 11 sequentially stores the mail numbers, the product codes, and the estimated delivery deadlines (shelf life, expiration date) contained in the ordered product list in the record form shown in FIG. 3 in the order management file 374. In addition, for the box number, assignment for each product is carried out corresponding to the ordered product list and the types and quantities of the products contained in the ordered product list. Also, the sequence number is provided in the order management file 374 for those ordered products with the same mail number.

At the time corresponding to each mail number, the person in charge of the picking operation in the store of the POS system (hereinafter to be referred to as picking operator) manipulates the online grocery store server 11 and issues by the printer 14 the picking slip extracted for each product category for the products contained in the ordered product list correlated to the corresponding mail number in the order management file 374.

The picking slip issuing process from the online grocery store server 11 will now be explained. The control part 31 of the online grocery store server 11 realizes the operation of the various types of functional parts (code symbol generating section 51, slip output section 52, code symbol assignment determination section 53, etc.) according to the picking slip issuing program stored in the storage part 37. Thus, the online grocery store server 11 carries out the picking slip issuing process.

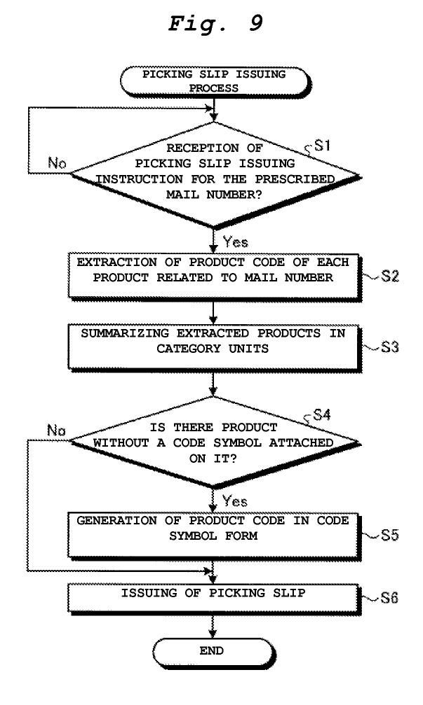

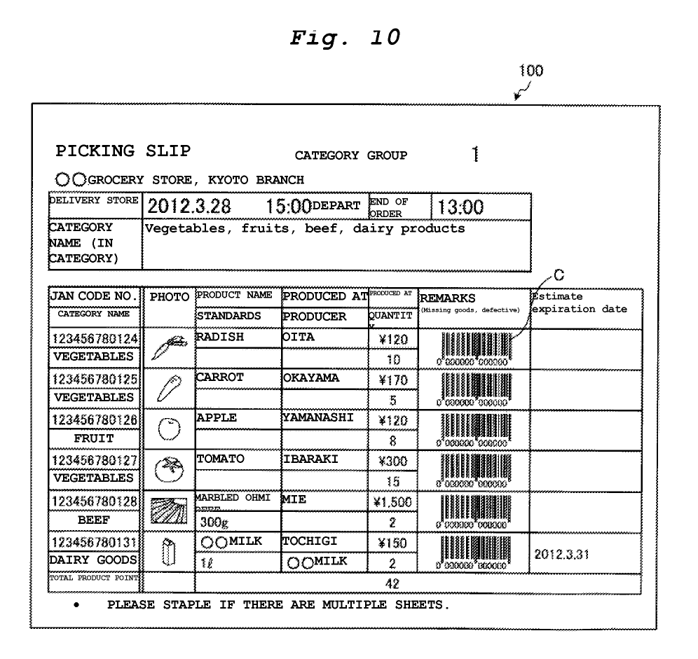

FIG. 9 is a flow chart illustrating the picking slip issuing process. As shown in FIG. 9, the picking operator carries out operation on the operation input part 35 (including a keyboard, mouse, etc.). On the basis of the current date/hour counted by the RTC (Real Time Clock) or other time counting unit not shown, the online grocery store 11 receives the instruction of the picking slip issuing (YES in step S1), and extracts the product code, the product name, the product image, the unit price, the quantity, and the estimated delivery deadline (shelf life, expiration date), etc. for each product related to the corresponding mail number in the order management file 374 (step S2).

The online grocery store server 11 summarizes the product code, the product name, the product image, the unit price, the quantity, and the estimated delivery deadline (shelf life, expiration date), etc. for each product related to the mail number in the category unit (step S3).

Then, the online grocery store server 11 determines whether there is a product that does not have a code symbol that is readable by the operation panel of the code scanner connected to the POS terminals 2 (code symbol assignment determination section 53), such as barcode or two-dimensional code or the like for the product (step S4). Examples of the products without the code symbols include vegetables, salads, fresh fish, and other categories. Consequently, the determination can be carried out in the category unit of the vegetables, salads, fresh fish, etc. In addition, determination on whether the product has the barcode, the two-dimensional code or other code symbol applied on it is not limited to the determination corresponding to the category the ordered product belongs to. It also include the case when a flag indicating that the code symbol is not applied is taken as a product information, or the case when a flag indicating no code symbol is applied is applied on the barcode, the two-dimensional code or other code symbol.

When it is determined that there is a product with a code symbol that is scannable by the operation panel of the code scanner (Yes in step S4), the control part 31 of the online grocery store server 11 (code symbol generating section 51) generates the product code of the product as the barcode, the two-dimensional code or other code symbol (step S5).

Then, the control part 31 of the online grocery store server 11 (slip output section 52) issues the picking slip for the various products related to the mail number. The picking slip includes the product code, the product name, the product image, the unit price, the quantity, and the estimated delivery deadline (shelf life, expiration date), as well as the code symbols, etc. if needed (step S6).

FIG. 10 is a plane view illustrating an example of the picking slip 100. As shown in FIG. 10, for each product related to the corresponding mail number in the order management file 374, the picking slip 100 has the following contents printed on it in the category units: the product code, the product name, the product image, the unit price, the quantity, and the estimated delivery deadline (shelf life, expiration date), etc. As the picking slip 100 printed in the category units is issued, it is possible to pick the products at high efficiency by each department.

In addition, for products not scannable by the operation panel of the code scanner (the product without a code symbol attached to it), the picking slip 100 has the barcode, the two-dimensional code or other code symbol C indicating the product code of the product printed as a piece of the product information in the column of “special items”. The code symbol C makes it possible to use the same picking procedures as with products that include a code symbol, by scanning the code symbol C of the picking slip 100. When it is determined whether a code symbol is applied to each of the ordered products, the picking slip 100 can be output in a state wherein the products without a code symbol attached are put together.

On the basis of the issued picking slip 100, the picking operator collects from the store the various products related to the corresponding mail number in the order management file 374. Then, the collected products are transferred to a loading area or the like.

As an example, suppose two bottles of “OO milk” are ordered as an example for the picking slip 100 as shown in FIG. 10, even when the products are present at the store with expiration dates of 1 day, 3 days, or 4 days, the picking operator picks up the products with 3 days listed as the estimated delivery deadline of the picking slip 100. On the other hand, for the products without description of the estimated delivery deadline on the picking slip 100 (such as frozen foods, canned goods, etc.), the picking operator picks up those with the earliest expiration date.

In this way, by eliminating variability by setting the reference to the expiration date when the product is picked by the picking operator, it is possible to deliver to the customer the products with appropriate expiration dates, making it possible to improve customer satisfaction.

In the picking operation on the basis of the issued picking slip 100, when there is no product with an estimated delivery deadline (shelf life, expiration date) of 3 days on the picking slip 100 in the store, the picking operator may pickup the products after the estimated delivery deadline on the picking slip 100.

In this way, with the information processor in the present embodiment, by assigning the estimated delivery deadline B2 as a measure of safety for the product that has received a purchase order on the purchase image G1 sent to the terminal device after accepting access, the user of the online grocery store can purchase the product with ease of mind. For example, in the prior art, a customer who intends to purchase two bottles of milk would hesitate if there is no way to find out its expiration date. Now, he/she can take the estimated delivery deadline B2 as reference and make the purchase of the two bottles of milk with ease of mind. That is, when milk or other products with a short expiration date is purchased in the online grocery store, the user can purchase an appropriate quantity in consideration of the consumption rate just as in a real store.

The program executed in the embodiment may also be provided by storing it in ROM or the like beforehand. Also, the types of the recording media for storing the program include CD-ROM, floppy disk (FD), CD-R, DVD, and other non-transitory computer-readable storage medium where the program is stored as a file in a format that can be installed or executed by a computer to cause the computer to perform the functions described above.

One may also adopt a scheme in which the program is stored in a computer connected to internet or other network, and it can be downloaded via the network for use. Also, the program may be provided or distributed via internet or other network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
an accepting module configured to accept access from a terminal device connected via a network,
an image generating module configured to generate a purchase image including an order for purchase of one or more products, and
an image sending module configured to send the purchase image to the terminal device; wherein
the purchase image includes an order deadline for accepting the purchase order as a measure of safety for the product.

2. The information processor according to claim 1, wherein
the order deadline is based on an expiration date of at least one of the one or more products and an estimated delivery time.

3. The information processor according to claim 2, wherein
when the order deadline has passed compared to a current time, and there is no second order deadline after the current time based on a like product having a different expiration date or a different estimated delivery time the purchase image indicates that the product is out of stock.

4. The information processor according to claim 2, wherein the purchase image includes the estimated delivery time.

5. The information processor according to claim 2, wherein the order deadline is further based on a product category to which the product belongs.

6. The information processor according to claim 1 further comprising a picking slip generating module configured to generate a picking slip including the order, wherein the one or more products are organized by product category on the picking slip.

7. The information processor according to claim 1, further comprising a stock management module configured to track inventory information of the one or more products based on accepted purchase orders and purchases made in a physical store.

8. The information processor according to claim 7, wherein the inventory information includes quantity information for at least two like products that differ only in respective expiration dates.

9. A non-transitory computer-readable storage medium that stores a computer program that causes a computer to perform as:
an accepting module configured to accept access from a terminal device connected via a network;
an image generating module configured to generate a purchase image including an order for purchase of one or more products; and
an image sending module configured to send the purchase image to the terminal device,
wherein the purchase image includes an order deadline for accepting the purchase order as a measure of safety for the product.

10. The non-transitory computer-readable storage medium according to claim 9, wherein the order deadline is based on an expiration date of at least one of the one or more products and an estimated delivery time.

11. The non-transitory computer-readable storage medium according to claim 10, wherein
when the order deadline has passed compared to a current time, and there is no second order deadline after the current time based on a like product having a different expiration date or a different estimated delivery time, the purchase image indicates that the product is out of stock.

12. The non-transitory computer-readable storage medium according to claim 10, wherein the purchase image includes the estimated delivery time.

13. The non-transitory computer-readable storage medium according to claim 10, wherein the order deadline is further based on a product category to which the product belongs.

14. The non-transitory computer-readable storage medium according to claim 9, wherein the stored computer program further causes a computer to perform as a picking slip generating module configured to generate a picking slip including the order, wherein the one or more products are organized by product category on the picking slip.

15. The non-transitory computer-readable storage medium according to claim 9, wherein the stored computer program further causes a computer to perform as a stock management module configured to track inventory information of the one or more products based on accepted purchase orders and purchases made in a physical store.

16. The non-transitory computer-readable storage medium according to claim 15, wherein the inventory information includes quantity information for at least two like products that differ only in respective expiration dates.

17. An information processor comprising:
an access module configured to access a server;
an ordering module configured to send an order request for one or more products selected for purchase; and
an image receiving module configured to receive a purchase image including order information for the one or more products selected for purchase, wherein
the purchase image includes an order deadline for confirming the order as a measure of safety for at least one of the one or more products.

18. The information processor according to claim 17, further comprising a display module configured to display the purchase image.

19. The information processor according to claim 17, further comprising an input device configured to confirm the order.

20. The information processor according to claim 19, wherein the purchase image further includes order information for at least two like products that differ only in respective expiration dates.
